(19) United States
(12) Patent Application Publication
(10) Pub. No.: US 2010/0263556 A1
(43) Pub. Date: Oct. 21, 2010

(54) Rolling Cookie, Pastry, Pizza, and Pasta Tool

(76) Inventors: Grigore Axinte, Bellevue, WA (US); Daniela Axinte, Bellevue, WA (US); Vasilica Axinte, Bellevue, WA (US); Dragos Axinte, Bellevue, WA (US)

Correspondence Address: Dragos Axinte, 1400 SE Bellevue Way, Unit 13, Bellevue, WA, 98004, US

(21) Appl. No.: 12/761,348

(22) Filed: Apr. 15, 2010

Related U.S. Application Data
(60) Provisional application No. 61/169,818, filed on Apr. 16, 2009.

(51) Int. Cl. A47J 43/00; B26B 1/00

(52) U.S. Cl. 99/537; 30/320

(57) ABSTRACT

A multi-functional cooking utensil that is configurable as a roller, cutter, or docker. In some embodiments, cookie cutters attach to a roller accessory via magnets. In some embodiments, spacers and additional cutting discs are used to adjust a pasta cutter accessory. The utensil has adjustable arms and handle to facilitate easy exchange and use of accessories.

This application claims the benefit of U.S. Provisional Patent Application No. 61/169,818 filed 16 Apr. 2009, all of which is incorporated herein by reference.

### TECHNICAL FIELD

This disclosure relates generally to improvements to a rolling cooking utensil used for preparing food such as cookies, pastries, pizza, and pasta dough.

### BACKGROUND

Baking is familiar to most people as the art of cooking food in an oven. Bakers usually prepare baked goods such as bread, cakes, cookies, pastries, and pies. Nearly all Americans households will bake in 2010, buying billions of dollars in baked goods, dough, cake mixes, etc. Despite the ubiquity of baking, there is a paucity of adequate tools to assist the home baker.

One of the main tasks of a baker is to make and prepare dough. Bakers flatten dough on a hard surface such as a cutting board and cut cookies, pasta, or pie crusts from it. Rolling pins, cookie cutters, and pasta cutters are well known and commercially available baking utensils. However, each of these tasks generally require a separate tool: a rolling pin for flattening dough; a cookie cutter for cutting cookie shapes from the dough; a pasta cutter for cutting pasta from the dough; a crust cutter for cutting dough into a crust; a dough docker for perforating the dough, etc. None of these existing cooking utensils are completely satisfactory solutions to the problem of preparing dough for baking.

Baking is a healthy alternative to other cooking methods such as deep-frying, because cooking in an oven does not require immersing the food in oil or fat. So makers of snacks such as potato chips and French-fries are turning to baking in an effort to produce healthier food. Nevertheless, new cooking utensils for home use have not been forthcoming from these efforts.

For these and other reasons, there is a need for a baking utensil and system that overcomes limitations of current baking tools, as well as providing additional benefits.

### SUMMARY

Presented first are a brief summary of some embodiments and aspects of the invention. Some simplifications and omissions may be made in the following summary; the summary is intended to highlight and introduce some aspects of the disclosed embodiments, but not to limit the scope of the invention. Thereafter, a detailed description of some illustrated embodiments is presented, which will permit one skilled in the relevant art to make and use aspects of the invention. One skilled in the relevant art can obtain a full appreciation of aspects of the invention from the subsequent detailed description, read together with the Figures, and from the claims (which follow the detailed description).

Embodiments of the disclosed inventions include a multi-functional cooking utensil that is configurable as a roller, cutter, or docker. The presently preferred embodiment is a rolling cookie, pastry, pizza, and pasta tool that utilizes interchangeable components to fit the functions of cookie cutting, pasta cutting, pie and pizza cutting, dough cutting, and a rolling pin attachment. In some embodiments, cookie cutters attach to a roller accessory via magnets. In some embodiments, spacers and additional cutting discs are used to adjust a pasta cutter accessory. The utensil preferably has adjustable arms and handle to facilitate easy exchange and use of accessories/attachments.

Embodiments of the disclosed innovations combine multiple functions into one apparatus, thus eliminating the need for multiple utensils. Additionally, the proposed invention requires less storage space and provides for more convenient cleaning.

Some embodiments use magnets as means to connect decorative cutting shapes to the main cylindrical rotor. This allows the user to easily replace the various cookie, pasta, pastry, and dough cutters.

Some embodiments have extendable arms that allow for use of cylindrical rotors of various lengths.

Some embodiments use spacers of various widths and a multitude of cutting discs to cut parallel dough strips. The user can customize both the width of the strip and the number of strips being cut.

Some embodiments can be configured to use a compass-like cutting method, which allows the users to cut circular shapes, such as those used for pie crusts and pizza dough. This mechanism allows the user to customize the diameter of the circular dough shape.

### BRIEF DESCRIPTION OF THE DRAWINGS

FIG. 1 shows a view of an embodiment of the innovative cooking utensil.

FIG. 2 shows a perspective view of an embodiment of a cylindrical rotor.

FIG. 3 shows a front and back view of a decorative shape sample.

FIG. 4 shows an exploded view and details of the adjustable width cutter attachment.

FIG. 5 shows a perspective view of the rolling pin attachment.

The headings provided herein are for convenience only and do not necessarily affect the scope or meaning of the claimed invention.

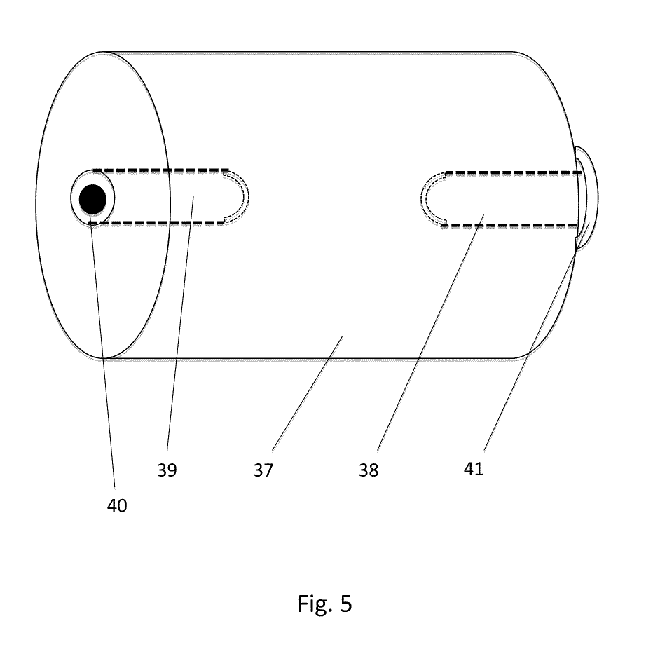

In the drawings, the same reference numbers and acronyms identify elements or acts with the same or similar functionality for ease of understanding and convenience. To easily identify the discussion of any particular element or act, the most significant digit or digits in a reference number may refer to the Figure number in which that element is first introduced (e.g., element 505 is first introduced and discussed with respect to FIG. 5).

Figure numbers followed by the letters “A,” “B,” “C,” etc. may indicate that two or more Figures represent alternative or related embodiments or methods under aspects of the invention.

### DETAILED DESCRIPTION OF THE ILLUSTRATED EMBODIMENTS

The following description provides specific details for a thorough understanding of, and enabling description for, these embodiments of the invention. However, a person of ordinary skill in the art will understand that the invention may be practiced with many variations and these details do not list every possible variation. In some instances, well known structures and functions have not been shown or described in detail to avoid unnecessarily obscuring the description of the embodiments of the invention.

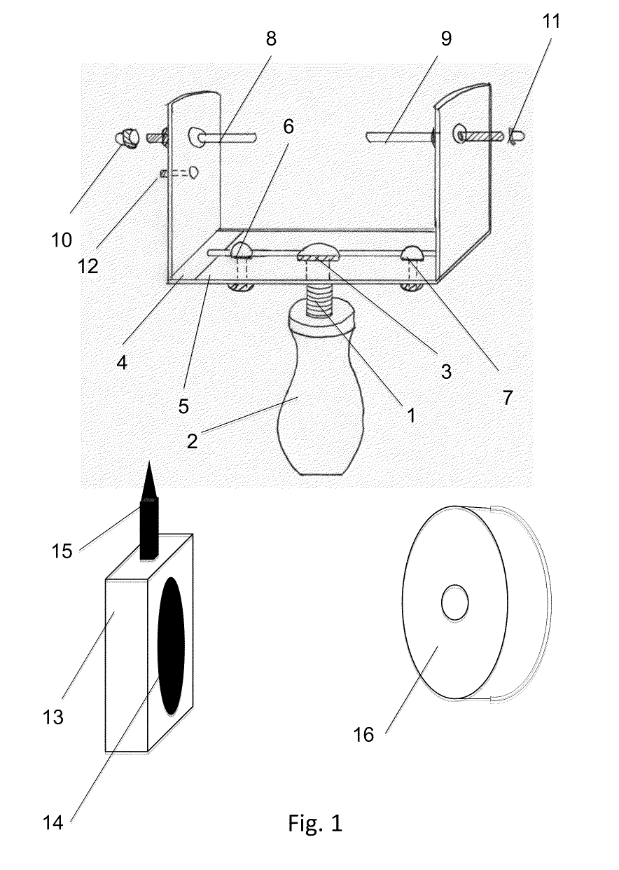

FIG. 1 shows an embodiment of a multifunctional cooking utensil according to some aspects of the present invention. The cooking utensil can, with various attachments, be used to roll, cut, or perforate dough. The presently preferred embodiment is composed of a threaded shaft 1, and ergonomic handle 2, a shaft knob 3, two width-adjustable arms 4 and 5, two knobs 6 and 7, two axial shafts 8 and 9, two knobs 10 and 11, a protrusion 12, a needle mechanism 13, and a cutting disc 16.

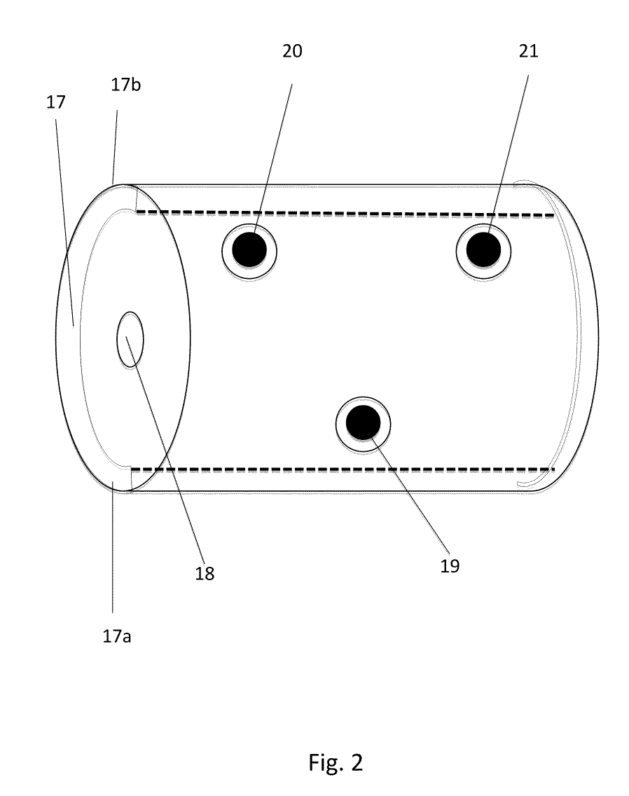

FIG. 1 shows the rolling cookie, pastry, pizza, and pasta tool's axial shafts 8 and 9, in which the user inserts an accessory or attachment such as the cylindrical rotor 17 shown in FIG. 2. To insert rotor 17, the user first loosens the knobs holding the width-adjustable arms 4 and 5, pulls the arms away from each other, thereby increasing the distance between the arms, inserts the rotor 17 onto shafts 8 and 9, and finally pushes the arms towards each other to hold the rotor. The cylindrical rotor 17 is secured into place by knobs 10 and 11 and rotates as the cooking utensil is pushed or pulled across the dough.

Once the cylindrical rotor 17 is in place, the user tightens knobs 6 and 7 to secure the width-adjustable arms 4 and 5, making sure that the handle 2 is positioned half way between the extremities of width-adjustable arms 4 and 5. To secure the entire system in place the user twists clockwise the handle 2, which tightens the threaded shaft 1 and shaft knob 3.

Once ready to use, the user places the cylindrical rotor 17 against the dough and pushes the tool forward, much like the movement of a paint roller.

To cut circular dough shapes, such as pie or pizza crusts, the user attaches the needle mechanism 13 to one adjustable arm by sliding the channel 14 over protrusion 12 and the threaded end of knob 10. The needle mechanism 13 is then secured into place by tightening knob 10. The cutting disc 16 is attached to the second arm and secured into place by tightening knob 11. To cut a circle in the dough, the user places the needle 15 at the center point of the circle and rotates the cutting wheel around the perimeter of the circle. The diameter of the circular shape being cut is determined by adjusting the width of the adjustable arms 4 and 5.

The adjustable arms, the knobs, and the threaded ends of the knobs are preferably made of materials such as plastic or metal coated with an anti-rusting agent. The handle is preferably made of materials such as plastic, wood, plastic with rubber overmold, or other long-wear, ergonomic materials or a combination of them.

FIG. 2 shows an embodiment of a cylindrical rotor 17 according to some aspects of the invention. The cylindrical rotor 17 is composed of an internal cylindrical rotor 17a, an external cylindrical rotor 17b, an axial channel 18, and three magnet caps or orifices 19, 20, and 21. The external cylindrical rotor 17b is preferably made of a material such as plastic, rubber, or a non-ferrous material such as aluminum or copper. The internal cylindrical rotor 17a is preferably made of ferrous metals. Although the embodiment shown has magnet caps or orifices 19, 20, and 21, some embodiments may not have these elements, depending on the intended function of the rotor (e.g., a rotor accessory configured as a docker may not have the magnet caps or orifices).

An alternative embodiment utilizes an internal cylindrical rotor made of plastic and having several strips or caps of metal that are exposed to the magnetic caps or orifices 19, 20, and 21. In an alternative embodiment, magnets on the cutter(s) would hold the cutter(s) to the rotor.

The axial channel 18 allows the cylindrical rotor 17 to be connected to the axial shafts 8 and 9. The cylindrical rotor 17 is secured into place by knobs 10 and 11.

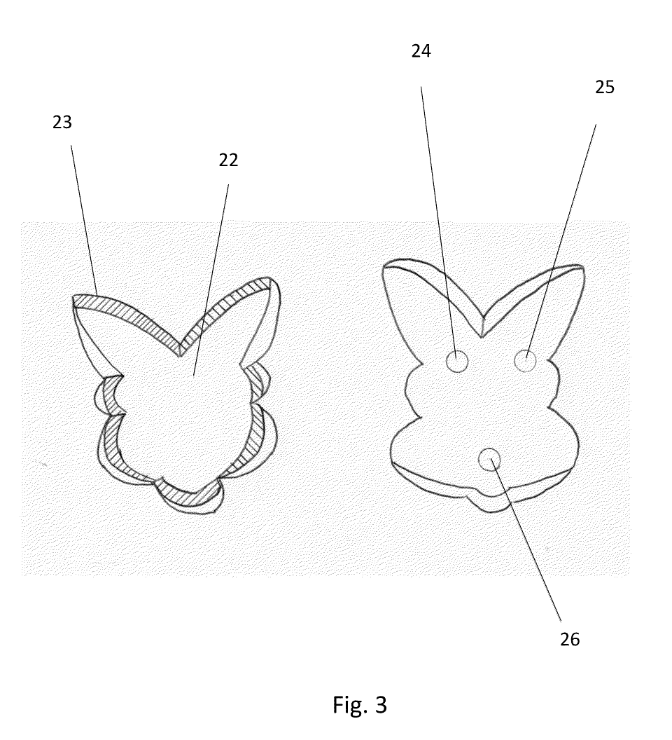

FIG. 3 shows an embodiment of a decorative cutter 22 used for cutting cookies, pastry, or pasta dough, according to some aspects of the present invention. These cutters can be any chosen pattern—holiday themes, flowers, animals, birds, insects, cartoon characters or various pasta shapes such as ravioli, stars, etc. Those skilled in the art recognize the multitude of pattern possibilities for the interchangeable decorative cutters 22. The decorative cutter 22 has a cutting edge 23 and three magnetic caps 24, 25, and 26, through which the cutter is attached to a representative cylindrical rotor. The decorative cutter 22 is made of materials such as metal, plastic, or rubber. Although three magnetic caps have been discussed in the context of the FIGS. 2 and 3, more or fewer magnetic caps and orifices could be used to attach the decorative cutter to the rotor.

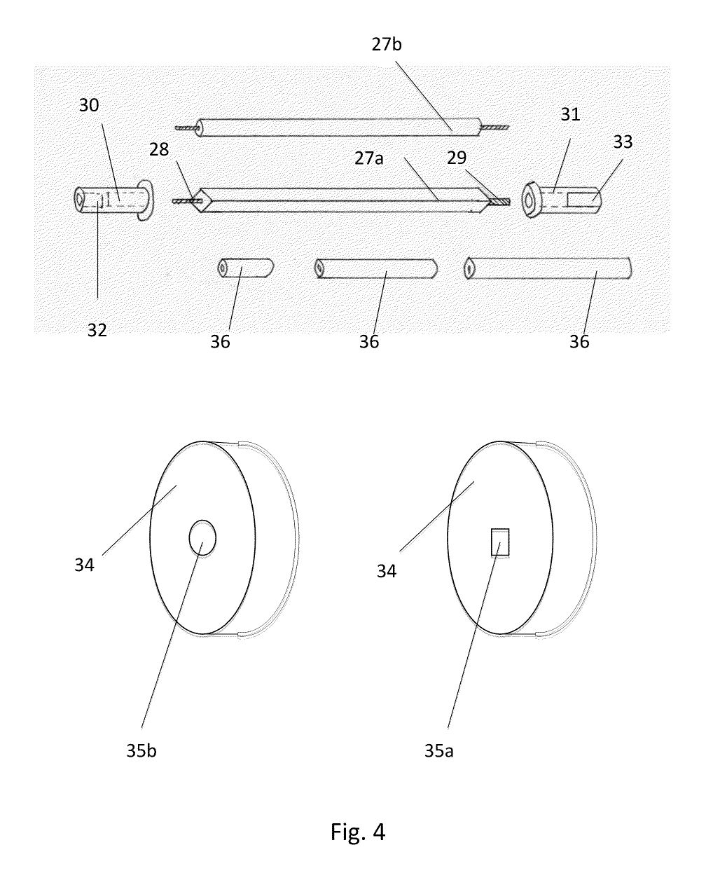

FIG. 4 shows the adjustable width cutter attachment utilized for cutting strips of dough of various widths. In the embodiment shown, the attachment consists of a square shaft 27a, threaded terminals 28 and 29, two knobs 30 and 31, multiple disc cutters 34, and multiple spacers of various widths 36. Depending on the chosen width of the dough strips, the user selects the width of the spacer 36 and, therefore, the number of disc cutters 34.

An alternative embodiment utilizes an assortment of attachments with the multiple disc cutters 34 set at predetermined, fixed positions.

The spacers 36 and disc cutters 34 are inserted on square shaft 27a alternately. Then the user tightens knob 30 and 31. The internal channels 32 and 33 of knobs 30 and 31 are then slid into the axial shafts 8 and 9 and tightened into place with knobs 10 and 11. This attachment can be utilized to cut long pasta, such as linguini, or dough strips for decorating pies, or to create squares and rectangles of various widths and lengths.

The square shaft 27a, the spacers 36, and disc cutters 34 are preferably made of materials such as plastic, rubber, or metal coated with an anti-rusting agent or a combination of these.

An alternative embodiment utilizes a cylindrical shaft 27b. Accordingly, the shaft hole 35 of the disc cutters 34 will be circular (35b) instead of square (35a). Other alternative embodiments could use a triangular shaft, a hexagonal shaft, or any other suitable geometric shape with shaft hole 35 of cutter 34 configured to match the shaft.

Yet another alternative embodiment utilizes a magnetic shaft, of any suitable geometrical shape, and ferrous metal disc cutters 34. The geometrical shape of shaft hole 35 will correspond to the geometrical shape of the shaft 35 being used. The disc cutters 34 will be place in the desired position, at the space determined by the user. The electromagnetic force between the magnetic shaft 35 and the ferrous metal disc cutters 34 will keep the disc cutters in the desired position without the need of spacers 36.

FIG. 5 shows a rolling pin attachment 37 used for flattening dough. The rolling pin attachment slides into axial shafts 8 and 9 through interior channels 38 and 39, and it is secured into place by knobs 10 and 11. The interior channels 38 and 39 have terminal ends 40 and 41. The rolling pin attachment 37, the interior channels 38 and 39 and terminal ends 40 and 41 are preferably made of materials such as plastic, wood, rubber, or metal coated with an anti-rusting agent. Although FIG. 5 shows a cylindrical rolling pin, any suitable rolling pin shape can be used. A tapered rolling pin may be a suitable substitute, for example. A dough docker may also be a suitable substitute in situations in which the baker desires to perforate the flattened dough.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The above detailed descriptions of embodiments of the invention are not intended to be exhaustive or to limit the invention to the precise form disclosed above. While specific embodiments of the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not necessarily the embodiments described herein. These and other changes can be made to the invention in light of the detailed description.

Aspects of the invention can be modified, if necessary, to employ the systems, functions and concepts of the various references described above to provide yet further embodiments of the invention.

These and other changes can be made to the invention in light of the above detailed description. In general, the terms used in the following claims should not be construed to be limited to the specific embodiments disclosed in the specification, unless the above detailed description explicitly defines such terms. For example, although rolling and cutting dough has primarily been discussed, the disclosed innovations could apply to other comestibles. Accordingly, the actual scope of the invention encompasses the disclosed embodiments and all equivalent ways of practicing or implementing the invention under the claims.

In view of the many possible embodiments to which the principles of this invention may be applied, it should be recognized that the detailed embodiments are illustrative only and should not be taken as limiting the scope of the invention. Thus, I claim as my invention all such embodiments as may come within the scope and spirit of the following claims and equivalents thereto.

1. A multi-function cooking utensil, comprising:
a handle assembly, wherein the handle assembly further comprises
a threaded shaft,
an ergonomic handle configured to receive the threaded shaft, and
a shaft knob;
a width-adjustable arm assembly, adjustably attached to the handle, wherein the arm assembly further comprises
a first L-shaped arm,
a second L-shaped arm, slidably attached to the first L-shaped arm, whereby the width between the arms can be adjusted, and
a first and second axial shaft for holding a rotor attachment, the first and second axial shafts attached to the first and second L-shaped arms, respectively;
whereby rotating the ergonomic handle in one direction will cause the handle and shaft knob to tighten against the arm assembly, thereby locking the arm assembly at its current width, and rotating the ergonomic handle in the other direction will cause the handle to loosen from the arm assembly, thereby unlocking the arm assembly to allow the user to change its width.

2. The multi-function cooking utensil of claim 1, further comprising a needle mechanism having a channel for engaging a feature on an arm, and having a needle.

3. The multi-function cooking utensil of claim 2, further the first L-shaped arm comprising a first knob removably attached to the first axial shaft and a protrusion, whereby the needle mechanism can be attached to the first L-shaped arm by fitting the channel over the first knob and the protrusion.

4. The multi-function cooking utensil of claim 3, further comprising at least one cutting disc for cutting dough, the cutting disc removably attached to the second axial shaft.

5. The multi-function cooking utensil of claim 1, further comprising a cylindrical rotor having a plurality of magnets for holding cutters to the cylindrical rotor.

6. The multi-function cooking utensil of claim 1, further comprising a pasta cutting assembly adjustable to vary the width and number of strips that it cuts.

7. The multi-function cooking utensil of claim 5, wherein the pasta cutting assembly has a plurality of spacers and cutting discs mounted alternately on a shaft, the shaft having knobs at both ends to hold the discs and spacers on the shaft, the knobs having internal channels to mate with the first and second axial shafts.

8. The multi-function cooking utensil of claim 5, wherein the pasta cutting assembly has a plurality of cutting discs magnetically attached to a shaft, the shaft having knobs at both ends, the knobs having internal channels to mate with the first and second axial shafts.

9. The multi-function cooking utensil of claim 1, further comprising a rolling pin attachment having terminal ends that fit into internal channels along the axis of the rolling pin, the terminal ends mating with the first and second axial shafts.

10. The multi-function cooking utensil of claim 1, further comprising a dough docking attachment having terminal ends that fit into internal channels along the axis of the dough docking attachment, the terminal ends mating with the first and second axial shafts.

11. A rotary cutter for cutting dough, comprising:
an external rotor;
an internal rotor, fixed to the external rotor and within the external rotor, the internal rotor further comprising magnets at predetermined locations for holding ferrous dough cutters against the outer surface of the external rotor in such a manner that when the cutter is rolled over dough, the dough cutters will cut the dough.

12. A multi-function cooking utensil, comprising:
a handle;
a width-adjustable arm assembly, attached to the handle, wherein the arm assembly further comprises
a first L-shaped arm,
a second I-shaped arm, slidably attached to the first L-shaped arm, whereby the width between the arms can be adjusted, and
a first and second axial shaft for holding a rotor attachment, the first and second axial shafts attached to the first and second L-shaped arms, respectively;
a locking mechanism, for locking the arm assembly at its current width; and
an attachment for processing dough, removably held by the first and second axial shaft, the attachment selected from the group of a rotary cutter attachment, a circle-cutting attachment, and an adjustable width pasta cutter attachment.

13. The multi-function cooking utensil of claim 12, wherein the group further comprises a rolling pin attachment and a perforator attachment.

14. The multi-function cooking utensil of claim 12, wherein the adjustable width pasta cutter attachment further comprises a user-configurable plurality of cutting discs and spacers to adjust the width and number of pasta strips that the utensil can cut in each pass.

15. The multi-function cooking utensil of claim 12, wherein the circle cutting attachment comprises a needle mechanism for anchoring the utensil at the center point of a circle and a cutting disc for cutting along the perimeter of the circle as the utensil is rotated through 360 degrees.
